(19) United States
(12) Patent Application Publication
(10) Pub. No.: US 2012/0006426 A1
(43) Pub. Date: Jan. 12, 2012

(54) High Range Flow Valve

(76) Inventor: Boris Gorelic, Kibbutz Glil Yam (IL)

(21) Appl. No.: 13/143,206

(22) PCT Filed: Jan. 5, 2010
(86) PCT No.: PCT/IB2010/050023

§ 371 Date: Jul. 5, 2011

(30) Foreign Application Priority Data
Jan. 5, 2009 (GB) 0900063.9

(51) Int. Cl. F16K 17/38; F16K 1/00

(52) U.S. Cl. 137/468; 251/318

(57) ABSTRACT

A high range flow valve for precise supply of both low and high flows. The valve comprises two or more plungers movable inside a housing wherein the movement of each plunger relative to an adjacent plunger or the housing gradually opens or closes a flow opening and thus determines a flow area. Each plunger controls a different flow rate range. Two such valves can be combined in one housing whereby temperature and supply rate can be controlled, for both low and high supply rates.

### FIELD OF THE INVENTION

The present invention relates to fluid flow rate control valves, and more specifically to valves with means for accurately controlling both low and high fluid flow rates.

### BACKGROUND OF THE INVENTION

There are applications which require precise control of the flow rate of a fluid (liquid or gas), both for high flow rates and for low flow rates. A high flow valve may be incapable of precisely controlling the rate of flow at low flow rates as typically a small change in the valve setting results in a large change in the flow rate. One solution is using two valves together, one for low flow rates, and the other for high flow rates, with appropriate interconnections. This is a complicated and costly solution. Setting a fluid temperature by mixing from hot and cold sources may add additional complexity.

A single faucet, compatible for both low and high flows, may require some complexity as well. For example, two parallel movement mechanisms may be required, each controlling a different rate. There may be a need for two housings, and several moving components. In addition, such a faucet would have to be properly isolated, thus adding complexity.

### SUMMARY OF THE INVENTION

The present invention relates to a fluid flow rate control valve device. The device is intended for precisely controlling both low and high fluid flow rates. A desired flow rate within the flow rate range can be achieved by gradually opening or closing the valve. The valve device (such as a faucet) is implemented using one housing, in which two or more plungers are placed. Each of these plungers affects one (a different) range of fluid flow, thus allowing a bigger dynamic range of the faucet.

As such, according to embodiments of one aspect of the invention there is provided a fluid flow rate control valve device adapted for controlling low and high fluid flow rates, comprising: a housing; two or more plungers disposed and movable inside the housing, wherein the movement of each plunger relative to an adjacent plunger or relative to the housing opens or closes a flow opening thereby determining a flow area, and each plunger is adapted to control a different fluid flow range.\

According to embodiments of another aspect of the invention there is provided a valve system having a housing with two faucet valves each valve comprising: a housing with an outlet and at least one inlet; two or more plungers disposed and movable inside the housing; and a plunger movement mechanism adapted to gradually move the two or more plungers between closed and open positions, wherein the movement of each plunger relative to an adjacent plunger or relative to the housing opens or closes a flow opening thereby determining a flow area, and each plunger is adapted to control a different fluid flow range.

In particular embodiments, the plungers are installed one within the other, so that the plungers are controllable by one movement mechanism. Each plunger may gradually open or close a flow area, thus determining the fluid flow rate for a certain supply range.

The housing as well as the plungers may be relatively simple, thus allowing lower cost and higher reliability. In some embodiments, the plungers may move in parallel within the housing and by this movement change the size of the flow area. Thus, it may be possible to develop a faucet, which has a certain behavior for low flow rates and behaves differently for high flow rates—this may be based on the shape of the housing, the plungers, and the plungers' movement within the housing. The diameter of the outer plunger can be made as large as desired, to achieve as large a flow rate as desired; still, at the lower of flow rates, fine control of the flow rate is achievable with the smaller diameter plunger(s).

In some embodiments, two or more plungers may be installed within the housing, moving in parallel to the housing, wherein when the faucet is closed, both plungers are in the closed position (e.g. at one side or at the “top” of the housing), sealing the valve opening and thus not allowing flow. According to certain embodiments, a simple movement mechanism, such as a bar controlled by a motor, can be used to gradually open a first plunger to set a desired low flow rate, by moving it in parallel with the bar and opening the flow area.

If a higher flow rate is required, the bar may be further moved in parallel to gradually move a second (larger) plunger, which can encircle the first plunger, and then set a gradually increasing higher flow rate. The second plunger is designed for a higher flow range and gradual increase in flow, thus the slope of the flow rate vs. control angle is steeper.

In some embodiments, additional plungers are disposed in the housing, such as a third plunger around the second, to control an additional higher flow rate.

The present valve device (with two, or more plunger valves), the increase in flow rate is gradual. When opening the valve, first the low flow rate range valve is opened; after that valve is fully open, the second (high flow rate range) is gradually opened. The valve is closed in the reverse order: first the high flow rate range valve is gradually fully closed, and then the low flow rate range valve is gradually closed. Throughout the control range of the double (or multiple) plunger valve, the control is gradual, with no jumps in the flow rate.

Two such valve devices can be combined together in one valve system, which is adapted to provide fluid at a certain temperature. In some embodiments, the valve device includes additional components such as a temperature sensor, motors and a controller, to help control the flow. In certain embodiments, the dynamic range of fluid (e.g. liquid, herein after used interchangeably) supply may vary from half a liter to 60 liters per minute. The design of the valve system, and the gradual control of liquid flow, may allow accurately controlling the size of the flow, to achieve a large dynamic flow range.

This valve system can be gradually opened or closed to regulate liquid flow such as water. The system may thus help prevent burns, for example by limiting water temperature. It can be used in spas, pools, residences or industry settings, or in any other application in which it is desired to control liquid supply rate and/or temperature. In some embodiments, water temperature and supply rate, and/or a change to either, is controllable via an electronic control system.

### BRIEF DESCRIPTION OF THE DRAWINGS

FIGS. 1A-1C schematically illustrate a high range flow valve according to the present invention, having two plungers.

FIG. 2 is a graph illustrating controlling liquid flow rate by a two-plunger device.

FIG. 3 is an exploded front view of an embodiment of the present valve system.

FIGS. 4-5 are respective side and front sectional views of FIG. 3, assembled.

FIGS. 6-8 are respective perspective and two cross-sectional side views of the plunger assembly shown in FIG. 3.

FIG. 9 is a schematic of an embodiment of the valve system with an external controller.

FIG. 10 is a schematic of an embodiment of a multiple faucet valve system of the present invention with an external controller.

### DETAILED DESCRIPTION OF EMBODIMENTS OF THE INVENTION

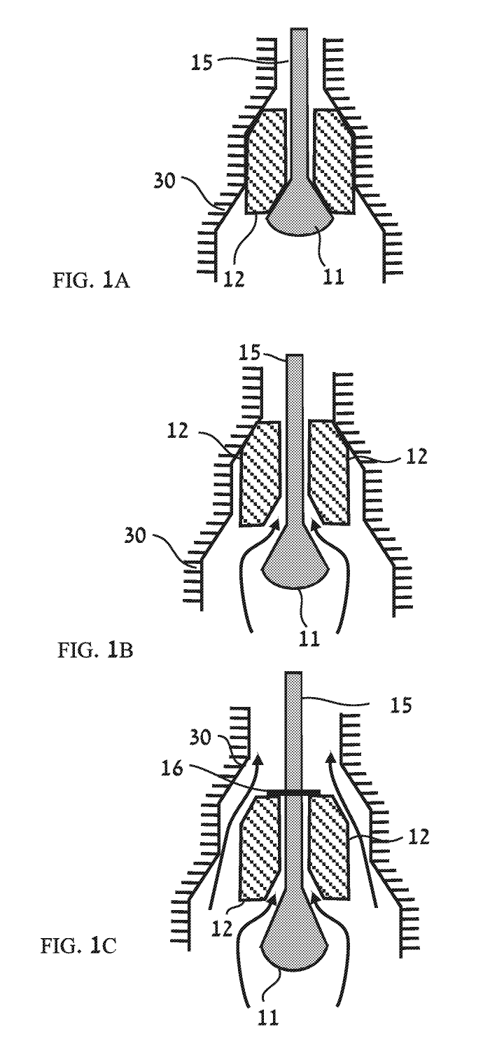

FIGS. 1A-1C illustrate a high range flow valve device exemplified by a faucet valve having two plungers, a low flow plunger 11 and a high flow plunger 12, disposed and moveable within a faucet housing 30. The water flows upwards and the two movable plungers 11, 12 control the size of the water flow area. By changing the water flow open area, the rate of water provided is controlled.

FIG. 1A shows the faucet with the valve closed, where the two plungers 11, 12 block water flow. Low flow plunger 11 can be opened by moving its bar 15 towards the inlet (downwards, in the drawing) and allowing water to flow, as shown in FIG. 1B. As a result of gradual movement of the low flow plunger 11, the supply of low water flow can be controlled by the size of the small opened area between the two plungers 11 and 12. When the bar 15 is further moved toward the inlet (FIG. 1C), a larger open area is created, as a result of the movement of the high flow plunger 12. A stop 16 prevents high flow plunger 12 from moving away from the inlet (upward in the drawing). Thus by moving the bar 15 downwards, the open area between high flow plunger 12 and the faucet housing 30 becomes larger, and the high flow water supply is controlled.

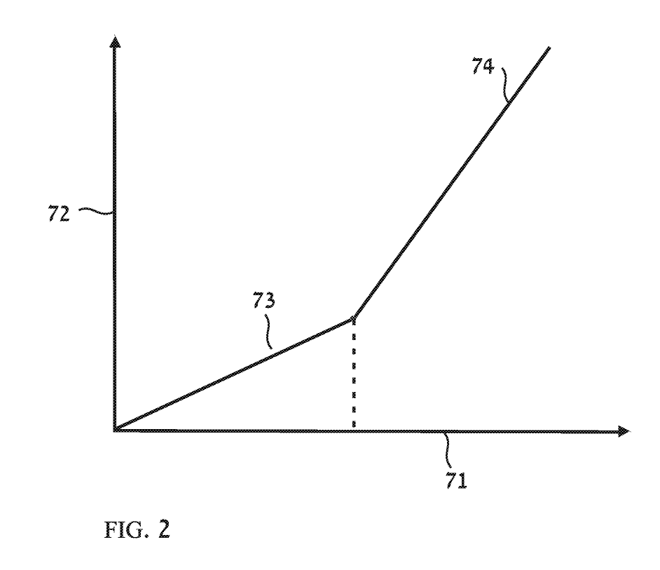

FIG. 2 illustrates controlling liquid flow rate by embodiments of the present valve device. Liquid flow rate 72 is a function of flow area, which can be determined by an opening angle 71 set. For example, in an embodiment equivalent to that described in FIGS. 1A-1C, for a small opening area there is a low flow 73, where only the low flow plunger 11 is opened, a small water flow supply can be set. After the high flow plunger 12 is also opened, a larger opening area is made and a higher water flow 74 supply can be set. Thus, using a device such as the high range flow faucet having low and high flow plungers 11 and 12, the dynamic range of the controlled flow can be effectively controlled, for both low flow 73 and high flow 74 ranges.

According to further embodiments, it may be possible to use more than two flow ranges, such as three, four or five ranges. This can be implemented, for example, by using three, four or five plungers respectively, e.g. one within each other, inside faucet housing 30. The opening angle 71 can be determined, for example by an electric stepper motor. In each additional range of the graph in FIG. 2, the slope would be higher—as a result of using the additional plungers, each controlling a larger flow area difference as a function of the bar's (or motor's, etc) movement.

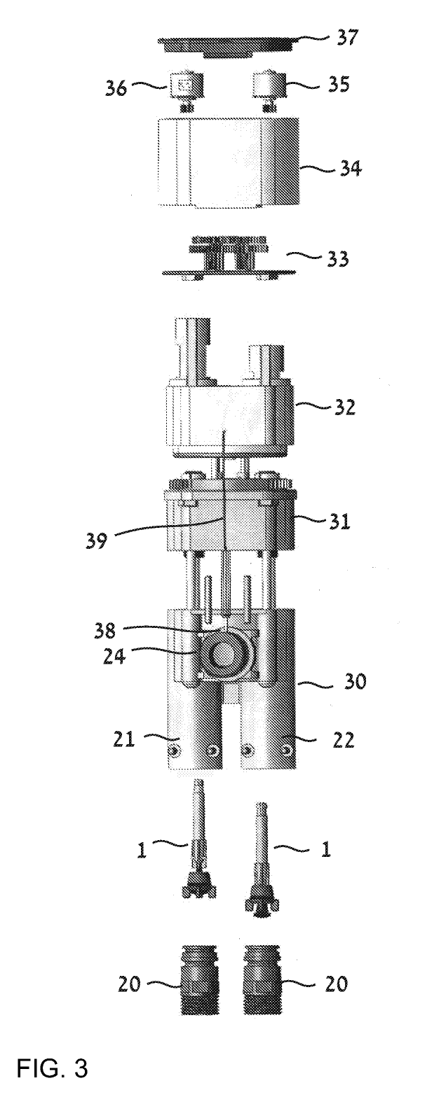

FIG. 3 shows an exploded front view of an embodiment of the valve system including two plunger assemblies 1 each comprising a low flow plunger 11 and a high flow plunger 12 for controlling the ratio of hot and cold water, as well as the total water supply provided through an outlet 24, which can be adapted to a certain type of pipe or spout. Two inlets 20, one for each plunger assembly 1, provide hot and cold water. The plunger assemblies 1 can vertically slide within the faucet housing 30, in order to control the amount of water entering from each inlet 20. Two electric motors 35, 36, such as stepper or DC motors, control each of the plunger assemblies 1 via a gear 33, for example. The gear 33 is connected to worm wheels and sliders (not seen), placed within a worm wheel casing 32 and slider casing 31, respectively. There is a pair of worm wheels and a pair of sliders for each of the plunger assemblies 1. A cover 37 keeps the plunger device closed and protected. A temperature sensor 38 is disposed at the faucet housing 30 near the outlet 24, for measuring the temperature of the water flowing out. The temperature reading is provided through temperature sensor wiring 39, for controlling the motors 35, 36 accordingly, and setting the water temperature by an electronic controller.

The two plunger assemblies 1 can be placed one next to each other, each with its respective movement mechanism (e.g. a first and a second movement mechanism) above it, which connects it to one of the motors 35, 36. Each of the plunger assemblies 1 can be placed at a different height—for setting the water supply provided. The device is typically symmetrical, thus the two plunger assemblies 1 and the movement mechanism controlling them are identical, with one controller, which sets the position of each of them.

The two adjacent motors 35, 36 each control one of the plunger assemblies 1 through the gear 33 and a worm wheel and a slider, placed one above each other. The plunger assemblies 1 are symmetric, each placed within one housing 21, 22 of the faucet housing 30.

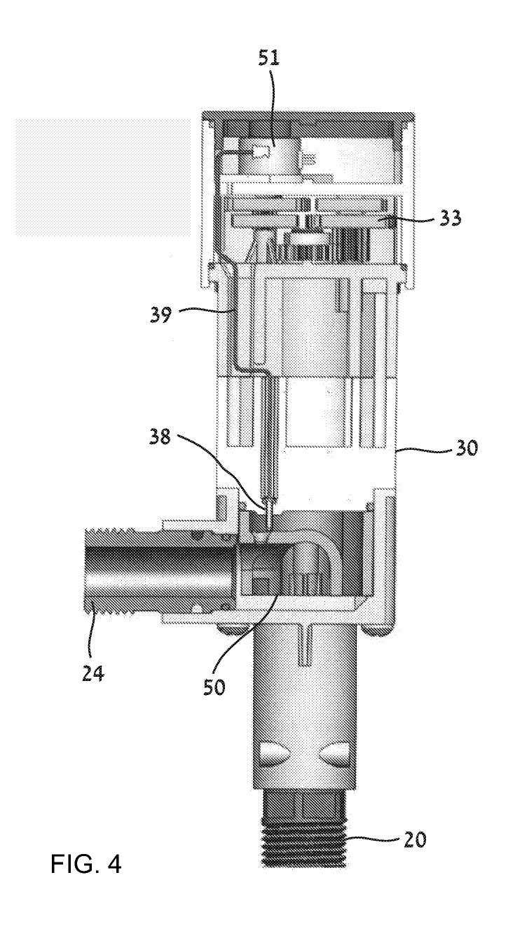

FIG. 4 details a cross-sectional side view of a valve system of the present device. Hot and cold water provided are mixed within a mixing chamber 50, where the temperature of the water is measurable by the temperature sensor 38. The temperature reading provided by the wiring 39 to a controller 51, which can control the motors 35, 36 and/or the gear 33, for moving the plunger assemblies 1 and thus changing water temperature and/or water supply rate. The fitting between the mixing chamber 50 and the outlet pipe or spout 24, can be of different diameter, this may also be effective for mixing the hot and cold water provided.

The controller 51 may comprise an electronic circuit, a chip a microcontroller and/or any other logic component(s). The controller 51 receives commands from an external source, such as for the amount and temperature of the water supply, and controls the motors 35 and 36 to ensure proper temperature control and flow rate.

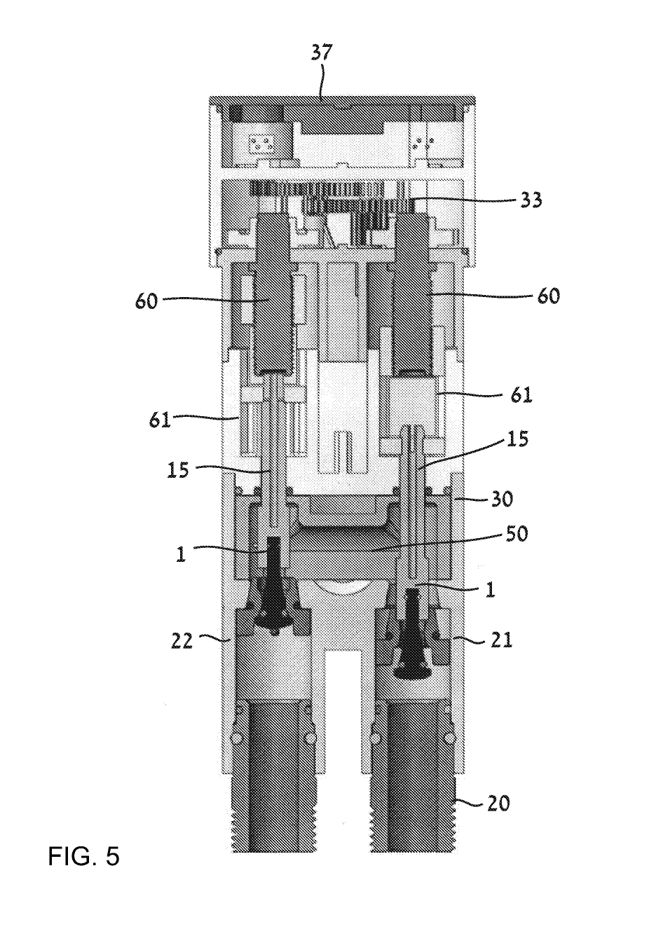

FIG. 5 shows further details of the present flow device. The internal top of the housings 21, 22 may be cone-shaped to match the plunger assembly 1. As seen, plunger assembly 1 is in an upward (sealed) position in housing 22 whereby the associated inlet is sealed and no water can enter. When the plunger assembly 1 is at a lower position, such as in housing 21, the inlet is gradually opened, and more water can flow. The rotational movement of the motors 35, 36 and gears 33 is converted to vertical movement by worm wheels 60 which rotate and move their sliders 61 upwards and downwards via their threads. Each slider 61 is connected to one of the bars 15 of the plunger assemblies 1. Thus the vertical position of each plunger assembly 1 can be set and secured by its respective motor 35, 36. The various components which are immersed or contact water can be isolated using O-rings. The device further comprises a means for connecting to an electric power source (or includes batteries); and in some embodiments a display (not shown) for inputting flow rate and/or temperature set points

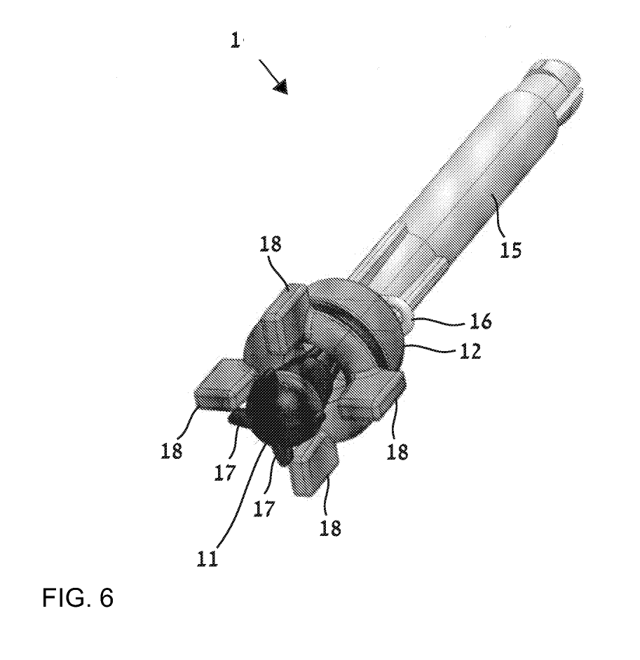

FIG. 6 shows an enlarged isometric view of one of the plunger assemblies 1 comprising low flow plunger 11 and high flow plunger 12. Low flow plunger 11 is disposed within high flow plunger 12 and includes bar 15. When low flow plunger 11 is pulled upwards, the area between the two plungers 11 and 12 is sealed and no water may flow therebetween. The low flow plunger 11 is shaped so that as it is moved downwards, the area between the two plungers increases whereby liquid flow upwards is increased. When reaching a certain range, based on the shape and setup of the plungers 11, 12, high flow plunger 12 is moved downwards together with the low flow plunger and the bar 15. Then additional flow area is opened between the high flow plunger 12 and the surrounding faucet housing 30. In some embodiments the faucet housing 30 is shaped wider towards the bottom to allow setting higher flow rate as a result of a larger open area. The faucet housing 30 is narrower at its top or tapered, such as cone-shaped to correspond to the shape of the high flow plunger 12.

In some embodiments, the low flow plunger 11 includes blades 17, such as the four symmetrical blades shown, to help locate the low flow plunger 11, as it moves vertically into the high flow plunger 12 (or the housing, as the case may be) as it is pulled upwards by the bar 15. In some embodiments, the high flow plunger 12 includes blades 18, for vertically stabilizing it within the faucet housing 30. Stop 16 sets the place in which the bar 15 would pull the high flow plunger 12 as it is moved downwards. According to other embodiments, the plungers 11 and 12 and the plunger assemblies 1 and/or the faucet housing 30 may be shaped in any other manner, allowing gradual increase in water supply as a function of the movement of the bar 15. This can be similar to the graph with reference to FIG. 2, so that water flow is linear in each range; or the flow curve can have a different shape—such as to allow more liquid in with smaller movement of the plunger assemblies 1. The faucet housing, 30 may have a constant internal diameter in all of its length except for on its top where the plunger assemblies 1 engages it.

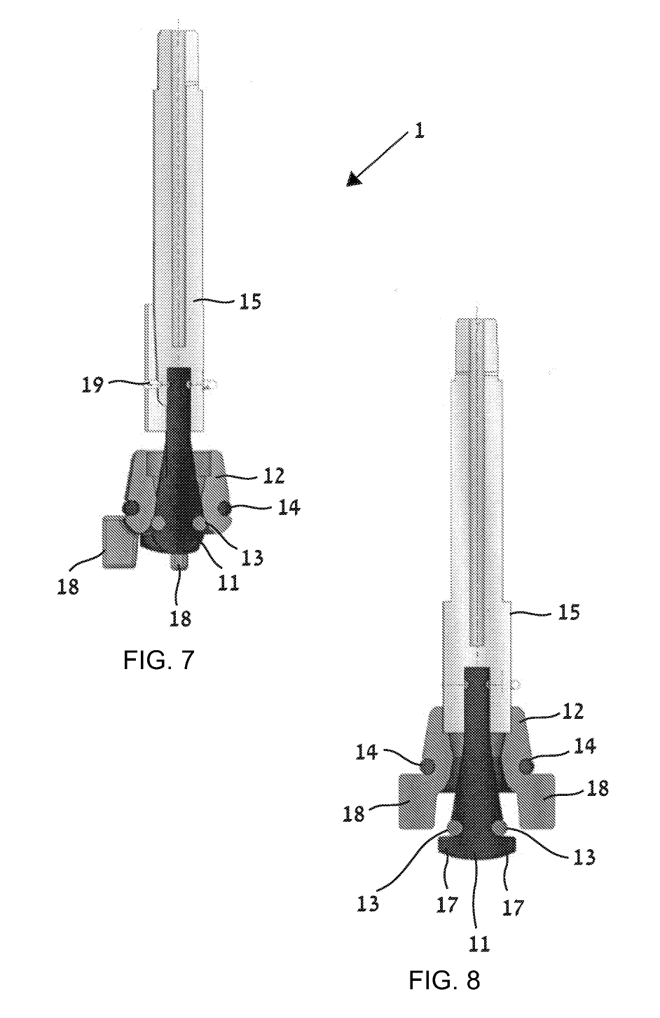

FIGS. 7 and 8 show cross-sectional side views of the plunger assemblies 1 of FIG. 6. The low flow plunger 11 is connected to the bar 15 with a connector 19 and has an O-ring 13 for isolating water between the low flow plunger and the high flow plunger 12 when the low flow plunger is at its upper position. High flow plunger 12 includes an O-ring 14 for isolating water between the high flow plunger and the faucet housing 30 when the high flow plunger is at its upper position. In some embodiments, high flow plunger 12 has a recess on its top, into which the bar 15 fits, as it moves downwards. This facilitates securing the bar 15 to the high flow plunger 12 and securing the high flow plunger to the faucet housing 30 by its blades 18. The water may continue to flow between the two plungers 11 and 12, as the bar 15 may be cross-shaped or X-shaped and so on (from a top view), so that water may flow all around it, and it does not capture much of the flow area.

In FIG. 7, low flow plunger 11, together with high flow plunger 12 and bar 15 is shown in its upper position, blocking flow. In FIG. 8 low flow plunger 11 is in a lowered position, enabling flow between the low flow plunger and high flow plunger 12. In addition, bar 15 may move high flow plunger 12 downward enabling additional flow between the high flow plunger and faucet housing 30. Thus, an effective faucet, which is compatible both for low and high flows, and can be controlled by vertical movement of one bar.

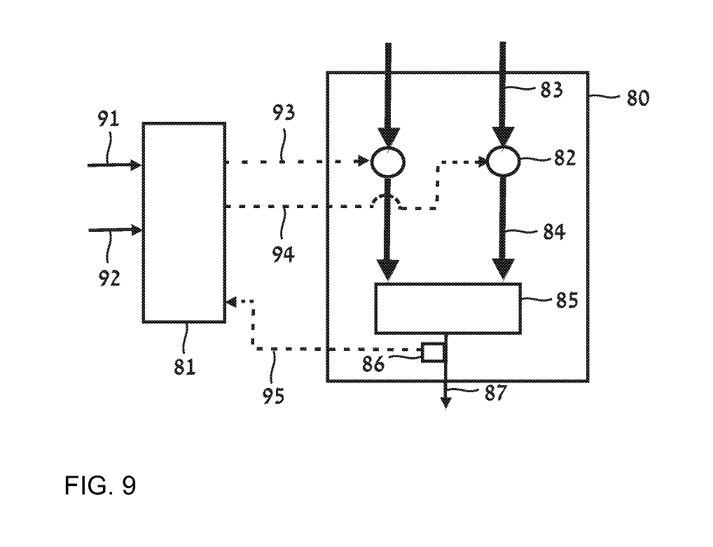

FIG. 9 shows a schematic of a high range flow valve system in accordance with the present invention, with an external controller 81. A high range flow faucet valve assembly 80, may be similar to the high range flow faucet valve described hereinbefore and/or may include two high range flow faucets 82, each adapted to supply both high and low flows, such as by using the plungers described. This high range flow faucet valve assembly 80, however, need not internally include the controller. This may reduce costs and further simplify implementation. The faucet valve assembly 80 has two water inlets 83 for hot and cold water, a water outlet 87, and wiring. Each of the faucets 82 may be controlled by a separate motor, which is controlled through its wiring 93 or 94. A temperature sensor 86 may include ADC and provide a digital or analog reading of the water temperature to the controller 81, through wiring 25. The controller 81 receives commands or may read a mechanic setup of one or more handles (not shown). For example, it may receive commands setting a desired water temperature 91 and supply rate 92. The controller 81 may comprise a microcontroller and/or may be implemented using any circuit, chip, etc. The controller 81 may also include digital memory, for saving commands, readings and the current faucet state.

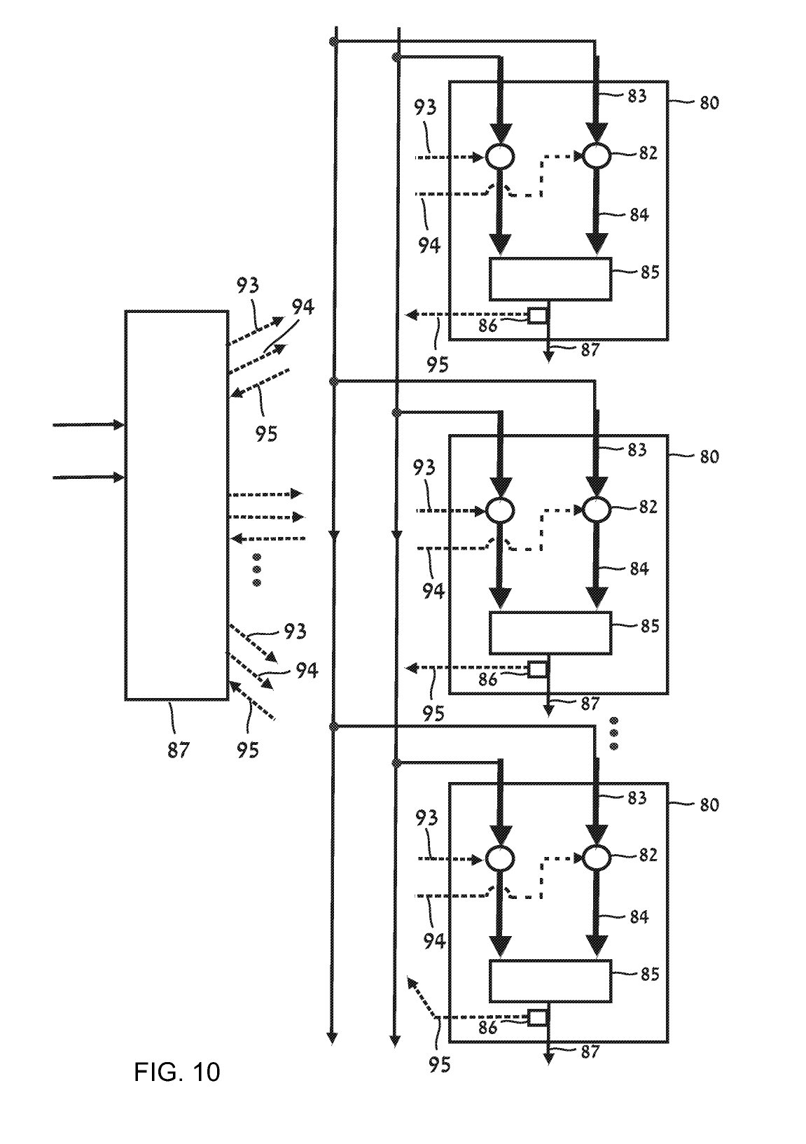

FIG. 10 shows a schematic depiction of high flow valve system with external controller 81 supporting a plurality of faucet valve assemblies 80. Each of the faucets 82 can be connected to cold and hot water supply pipes 97 and 98. The controller 81 may have multiplexing means for separately reading and controlling each of the faucets, or it may control them in parallel, simultaneously. Each of the wirings 91-95 may either be separate wirings or a bus of wires. Thus, all input and/or output commands may be provided over one or more common buses, for simplifying connection.

It will be recognized that the foregoing description provides embodiments of the apparatus and that various modifications will occur to those skilled in the art upon reading the disclosure set forth hereinbefore.

1. A fluid flow rate control valve device adapted for controlling low and high fluid flow rates, comprising:
a housing;
two or more plungers disposed and movable inside the housing, wherein the movement of each plunger relative to an adjacent plunger or relative to the housing opens or closes a flow opening thereby determining a flow area, and each plunger is adapted to control a different fluid flow range.

2. The device of claim 1, wherein the plungers are disposed one within the other.

3. The device of claim 1, having two plungers, one adapted for controlling a flow rate within a high flow range and another adapted for controlling a flow rate within a low flow range.

4. The device of claim 1, wherein the plungers are moved by one bar.

5. The device of claim 1, wherein the plungers and an inner space of the housing are cylindrical, and include means for stabilizing the plungers relative to the housing.

6. The device of claim 5, wherein the plungers include blades for stabilizing the plungers relative to the housing.

7. The device of claim 2, wherein an internal plunger controls flow in a relatively low flow range and the external plunger controls flow in a relatively high flow range.

8. The device of claim 7, wherein and when the valve is closed only the low flow plunger is adapted to move, for controlling the low flow range; and when the valve is opened above the low flow range, the high flow plunger is adapted to move for controlling the high flow range.

9. A valve system having a housing with two faucet valves each valve comprising:
a housing with an outlet and at least one inlet;
two or more plungers disposed and movable inside the housing; and
a plunger movement mechanism adapted to gradually move the two or more plungers between closed and open positions,
wherein the movement of each plunger relative to an adjacent plunger or relative to the housing opens or closes a flow opening thereby determining a flow area, and each plunger is adapted to control a different fluid flow range.

10. The valve system of claim 9, wherein the plunger movement mechanism is constituted by a first and a second movement mechanism.

11. The valve system of claim 10, further including a temperature sensor installed near the outlet and connected to a controller; wherein the controller controls the movement mechanisms of the plungers for setting fluid supply and temperature.

12. The valve system of claim 9, further including a temperature sensor installed near the outlet and connected to an external controller; wherein the controller controls several such plunger movement mechanisms for setting fluid supply and temperature.

13. The valve system of claim 9, further including a temperature sensor installed near one of two inlets of the at least one inlet.

14. The valve system of claim 9, further including a temperature sensor installed near each of two inlets of the at least one inlet.
